(19) United States
(12) Patent Application Publication
(10) Pub. No.: US 2023/0141334 A1
(43) Pub. Date: May 11, 2023

(54) SYSTEMS AND METHODS OF MODELING GEOLOGICAL FACIES FOR WELL DEVELOPMENT

(71) Applicant: ConocoPhillips Company, Houston, TX (US)

(72) Inventors: Alexander J. Wagner, Houston, TX (US); Christopher S. Olse S. Olsen, Houston, TX (US); Tahmineh Nazari, Houston, TX (US); Megan Potter, Houston, TX (US); Thiago B. Simoes Correa, Houston, TX (US); Daniel P. Sheehan, Houston, TX (US); Brackin A. Smith, Houston, TX (US); Douglas S. Moore, Houston, TX (US); Randy E. John, Houston, TX (US); Zachary A. Wallace, Houston, TX (US)

(21) Appl. No.: 17/982,839

(22) Filed: Nov. 8, 2022

Related U.S. Application Data
(60) Provisional application No. 63/276,884, filed on Nov. 8, 2021.

(51) Int. Cl. G06N 5/02

(52) U.S. Cl. CPC G06N 5/022

(57) ABSTRACT

Systems and methods include a geological structure modeling tool for generating a geological facies model for a target well with decision tree-based models. The decision tree-based models use geographic facie class as a target variable and receives an input data set including well log data, core data, and geological facie class labels (e.g., generated by a subject matter expert (SME)). A predictive analytics model using the decision tree-based models generates, based on an input of target well data, the geological facies model to represent underlying geological structures at a candidate location (e.g., for drilling a well) or a section of a subsurface reservoir (e.g., for resource characterization). Vertical context data can be provided to the decision tree-based models and the input data set can be artificially boosted based on geological facies class label occurrences. A well development action is selected for the candidate location based on the geological facies model.

### CROSS-REFERENCE TO RELATED APPLICATIONS

The present application claims priority to U.S. patent application Ser. No. 63/276,884 filed on Nov. 8, 2021, which is incorporated by reference in its entirety herein.

### FIELD

Aspects of the present disclosure relate generally to systems and methods for developing resources from subterranean reservoirs, and more particularly to modeling geological facies with decision tree-based models for well development.

### BACKGROUND

Large scale oil and natural gas reservoirs are generally complex in terms of geology and development. Some reservoirs, such as shales, are highly heterogeneous due to nanoscale pore size and highly variable structures. Characterizing reservoir geology in terms of geological facies, permeability, and natural fractures requires huge amounts of resources and remains a pervasive challenge. Performance and cost of a well is strongly driven by well development techniques, such as approaches in drilling, well placement, and completion over the life cycle of reservoir development. However, technology to reliably characterize and model physical properties of a reservoir to optimize well development is computationally expensive and insufficient.

Exacerbating these challenges is the cost-prohibitive nature of core sample extraction. Core samples are only extracted for a limited number of well sites. The vast majority of well sites do not undergo core sampling, leaving core sample data for reservoirs incomplete and fragmented. Moreover, the process of aggregating core samples into a three-dimensional map of the reservoir's geological structure is time consuming for complex, heterogeneous reservoirs with dozens of intersecting multi-layered geographic facies. Interpretation bias can be introduced by a subject matter expert (SME) during this process. The challenges only increase when modeling multiple wells with interference or communication between fractures.

As such, different data analytics techniques are limited in their ability to generate predictions for geological facies. Well location selection can be risky because of uncertain well development costs and production results when portions of a reservoir do not have complete or accurate geological structure data. It is with these observations in mind, among others, that various aspects of the present disclosure were conceived and developed.

### SUMMARY

Implementations described and claimed herein address the foregoing problems by providing systems and methods for generating a geological facies model using one or more decision tree-based models. In some instances, a method for modeling geological facies of a subsurface reservoir comprises: generating a predictive analytical model of the subsurface reservoir by: creating one or more decision tree-based models trained with an input data set including well log data associated with the subsurface reservoir; and assigning geological facies class as a target variable; receiving target well data corresponding to a target well associated with the subsurface reservoir; and generating, using the target well data and the predictive analytical model, a geological facies model for the target well.

In some examples, the well log data of the input data set includes core data associated with a plurality of wells at the subsurface reservoir. The method can further comprise labeling, using a subject matter expert (SME), the input data set with a plurality of geological facie class labels. The target well data can lack a core data set associated with the target well. Generating the predictive analytical model can include artificially balancing a plurality of geological facies class labels associated with the input data set to create a balanced input data set.

In some instances, the plurality of geological facies class labels includes between two and 20 geological facies class labels. Generating the predictive analytical model can further include providing vertical context data to the one or more decision tree-based models. The one or more decision tree-based models can include a gradient boosted decision tree. The well log data of the input data set can represent between five and 20 wells at the subsurface reservoir. The input data set can include at least one of resistivity data, gamma ray data, neutron porosity data, or bulk density data, sonic log data, dielectric log data, or nuclear magnetic resonance (NMR) logs. Generating the geological facies model for the target well can include numerically mapping the target well data to specific geographic facies represented by the input data set. The method can further comprise selecting, based at least partly on the geological facies model, a section of the subsurface reservoir for resource characterization. Moreover, in some instances, the target well is a candidate well for drilling, and the method further comprises: determining, based at least partly on the geological facies model, an optimal drilling location for the candidate well; and drilling the candidate well at the optimal drilling location.

In some examples, one or more tangible non-transitory computer-readable storage media storing computer-executable instructions for performing a computer process on a computing system, the computer process comprising the method(s) or any steps of the method(s) discussed herein. A system can be adapted to carry out the method(s) or any steps of the method(s) discussed herein. The system can comprise a wellbore modeling platform including the predictive analytics model trained with the decision tree-based models, the wellbore modeling platform receiving the target well data and generating the geological facies model for the target well.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

The foregoing summary, as well as the following detailed description, will be better understood when read in conjunction with the appended drawings. For the purpose of illustration, there is shown in the drawings certain embodiments of the disclosed subject matter. It should be understood, however, that the disclosed subject matter is not limited to the precise embodiments and features shown. The accompanying drawings, which are incorporated in and constitute a part of this specification, illustrate implementations of systems, methods, and apparatuses consistent with the disclosed subject matter and, together with the description, serve to explain advantages and principles consistent with the disclosed subject matter, in which:

FIG. 1 illustrates an example network environment that may implement various systems and methods discussed herein;

FIG. 2 is a block diagram illustrating an example data flow for generating a geological facies model using decision tree-based models, which may form at least a portion of any of the systems or methods discussed herein;

FIG. 3 illustrates an example system for optimizing a well development action using a predictive analytical model, which may form at least a portion of any of the systems or methods discussed herein;

FIG. 4 illustrates an example geological structure modeling tool for geological facie modeling, which may form at least a portion of any of the systems or methods discussed herein;

FIG. 5 illustrates example operations for optimizing a well development action by generating the geological facies model, which may form at least a portion of any of the systems or methods discussed herein;

FIG. 6 illustrates example operations for generating a geological facies model with a decision tree-based model, which may form at least a portion of any of the systems or methods discussed herein;

FIG. 7 illustrates example operations for generating a predictive analytical model to generate a geological facies model, which may form at least a portion of any of the systems or methods discussed herein; and

FIG. 8 illustrates an example computing system that may implement any of the systems or methods discussed herein.

### DETAILED DESCRIPTION

The present disclosure involves systems and methods for optimizing well development by generating a geological facies model for a candidate location. The system creates a predictive analytical model using decision tree-based models to classify input data with geological facies class being the target variable for the decision tree-based models. The input data can include well log data and core data. Due to the cost of collecting core samples, the core data may be a smaller (e.g., “minority”) data set relative to the well log data set.

Additionally, core data may be lacking for target well data associated with the candidate location. However, the techniques disclosed herein, in some instances, overcome these issues and provide accurate predictions for underlying geological structures at the candidate location. For instance, the system can artificially balance the input data set to generate a balanced data set, boost the decision tree to generate a boosted decision tree, and use vertical context data to further refine the models. Subject matter experts (SME)s can generate geological facies class labels to be associated with the input data, which can improve the accuracy and efficiency of the systems discussed herein. Moreover, geological facie models can be generated to predict geological structures at particular depths regardless of whether core data is available for the candidate location. The techniques can result in geological modeling with higher accuracy than other models (e.g., as measured with a randomly selected test population) and reduced processing requirements and memory requirements.

Moreover, because of the lower computational cost for predicting geological facies for candidate locations, a larger candidate area or zone of the subsurface reservoir (or reservoir field) can be assessed by generating multiple, iterative geological facies models for multiple locations in the candidate zone. A candidate location can be selected for well drilling, or a candidate zone for performing other well development actions (e.g., further resource characterization). These selections can be optimized based on the geological facies models. For instance, the geological facies models can indicate whether a predicted geological structure at the candidate location (e.g., based on the geology, petrophysics, rock properties, fluid properties, and/or the like) will output a resource amount above a threshold value. Furthermore, the predictions generated by the system can indicate equipment requirements, and corresponding costs, for well development at the candidate location. Accordingly, the efficiency of well development resource allocation is significantly improved.

Overall, the systems and methods improve reservoir development by providing predictions extrapolated beyond data limits for critical development decisions throughout the life of a reservoir field and its wells. Other advantages will become apparent from the present disclosure.

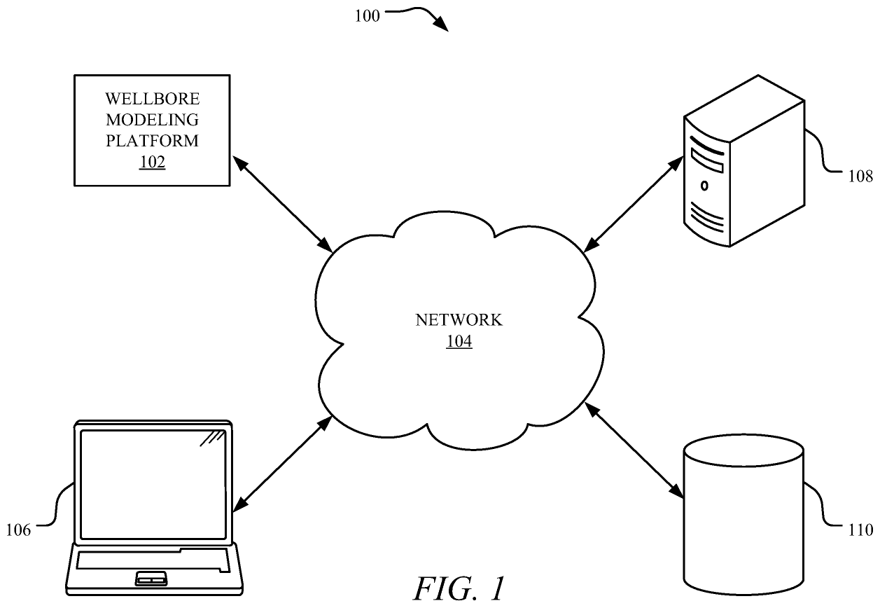

To begin a detailed discussion of an example system for modeling geological structures for a target well, reference is made to FIG. 1. FIG. 1 illustrates an example network environment 100 for implementing the various systems and methods, as described herein including a wellbore modeling platform 102. A network 104 is used by one or more computing or data storage devices for implementing the wellbore modeling platform 102. The wellbore modeling platform 102 may be a remote service, software as a service (SaaS) and/or cloud service for collecting and aggregating well-related and geological-related data from multiple sources. The wellbore modeling platform 102 can include software modules for analyzing the well-related and geological-related data and presenting the results. For instance, any of the software components (e.g., the decision tree-based models 206, the predictive analytics model 204, the geological facies model 202, etc.) discussed herein can be incorporated into the wellbore modeling platform 102 (e.g., as executable python script) to scale-up the software components and make them accessible to a variety of users in a multiple locations using many different types of computing devices.

In some implementations, various components of the wellbore modeling platform 102, one or more user devices 106, one or more databases 110, and/or other network components or computing devices described herein are communicatively connected to the network 104. Examples of the user devices 106 include a terminal, personal computer, a smart-phone, a tablet, a mobile computer, a workstation, and/or the like.

A server 108 may, in some instances, host the system. In one implementation, the server 108 also hosts a website or an application that users may visit to access the network environment 100, including the wellbore modeling platform 102. The server 108 may be one single server, a plurality of servers with each such server being a physical server or a virtual machine, or a collection of both physical servers and virtual machines. In another implementation, a cloud hosts one or more components of the system. The wellbore modeling platform 102, the user devices 106, the server 108, and other resources connected to the network 104 may access one or more additional servers for access to one or more websites, applications, web services interfaces, etc. that are used for production decline modeling and/or generating a well production profile.

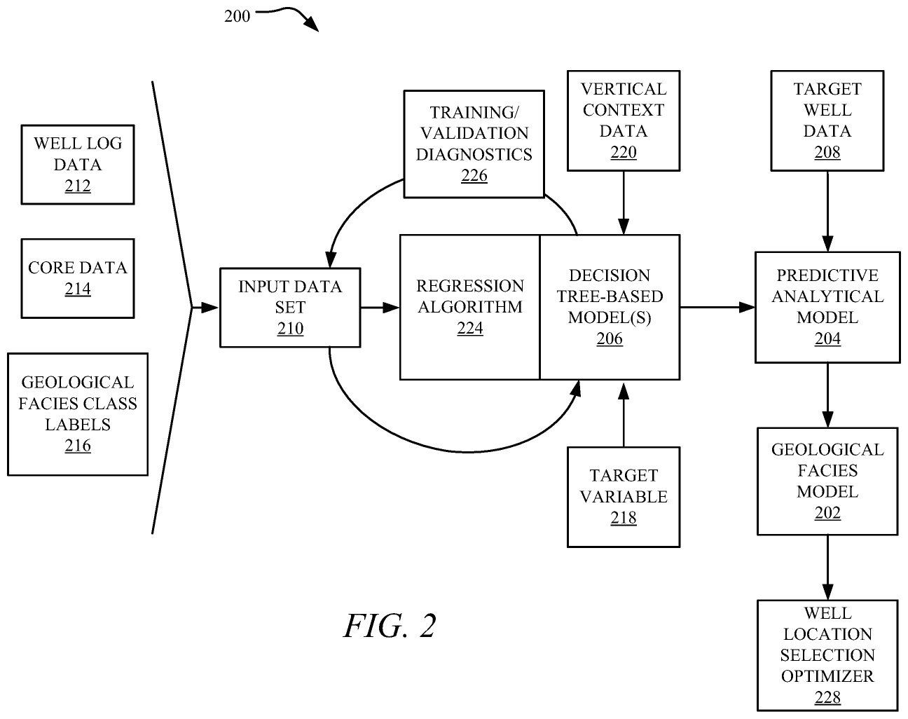

FIG. 2 is a block diagram illustrating an example data flow 200 for generating a geological facies model 202 with a predictive analytical model 204 by utilizing one or more decision tree-based models 206 and/or other machine learning techniques. The data flow 200 can be performed by any of the computing systems discussed herein and can include operations of an application or embedded plugin of the wellbore modeling platform 102. Through the data flow 200 of FIG. 2, the geological facies model 202 may be generated for a target well (and/or a candidate well location) based on target well data 208, which may lack corresponding core sample data (e.g., or a portion of core sample data). Rather, supervised machine learning, artificial intelligence, decision tree based model(s) 206, and/or other algorithms or techniques may be trained through an iterative and validation process to map the target well data 208 to specific geologic facies, represented by an input data set 210, for a faster and more accurate geological facies model 202 that does not necessarily rely on core data collected at the target well location. In some implementations, the steps outlined in the data flow 200 of FIG. 2 may be executed by the wellbore modeling platform 102 automatically or in response to inputs provided through a user interface to generate the geological facies model 202. In other instances, however, any component of the network environment 100 may execute one or more applications as described in relation to the data flow 200 of FIG. 2.

The data flow 200 may include generating the input data set 210 for input to the decision tree-based model(s) 206. The input data set 210 may include any well-related data, reservoir-related data, or geological-related data, such as but not limited to, well log data 212, core data 214, historical geological survey data, and petrophysical or other rock property data, rock property models, and/or flow simulation information data associated with a particular subsurface reservoir (e.g., a subterranean reservoir). The geological-related data can further include seismic data obtained through any known or hereafter developed seismic-based measurement techniques for determining subsurface characteristics. Well log data 212 may include well development data, well completion data, well production data, and/or any other records related to wells at the reservoir. For instance, well log data 212 can include data associated with a particular stage of the well life cycle, such as exploration and appraisal data or well abandonment data. Moreover, well log data 212 can indicate subsurface parameters, development and completion parameters, operation and facilities parameters, performance parameters, and/or the like. The subsurface parameters may include, without limitation, BVH, thickness, fractures, faults, FEV features, frac hits, landing targets, and/or the like. The development and completion parameters may include, without limitation, wellbore geometry, orientation, completion size, zipper, completion design, such as ppg, number per cluster, and/or the like. The operation and facilities parameters may include, without limitation, operating strategy, facility network, artificial lift, workover, remedials, water management, and/or the like. The performance parameters may include, without limitation, impacted, non-impacted, confined, unconfined, degradation, well life, event size, and/or the like.

In some examples, the input data set 210 can include the core data 214 associated with the reservoir. The core data 214 can be obtained, among other techniques, through analysis of one or more well-drilled core samples to determine the geological make-up at the well. The core data 214 can indicate geological data from the core sample, such as sedimentary compositions of geological facies sampled by the core sample and other geological-related information of the facies structures (e.g. a facies starting depth, a facies terminating depth, a facies interval size, a facies sedimentary composition, a facies porosity, a facies permeability, a facies wettability, one or more facies rock properties of the facies, a facies organic matter content, a presence of hydrocarbons or other fluids in the facies, a geomechanical property of the facies a fluid sensitivity of the facies, and the like). Additional geological-related data can be obtained from any known or hereafter developed physical model of rock characteristics, measurements, simulations, and the like. The number and types of data included in the input data set 210 may vary from model to model such that no particular types or amount of data is required to generate the geological facies model 202. Rather, any data sets can be supplied as input to the decision tree-based model(s) 206, although additional data may result in a more detailed geological facies model 202 being provided by the wellbore modeling platform 102.

In some examples, the well log data 212 and/or the core data 214 represent information related to a plurality of wells at a particular subsurface reservoir (e.g., an oil and/or natural gas reservoir region, reservoir field, reservoir zone, etc.) The core data 214 may represent core samples of between five wells and 20 wells (e.g., 8, 9, 10, 11, 12, etc.) which may be a small fraction of total number of wells at the reservoir (e.g., the total number of wells may be greater than 200 wells). The core data 214 may represent between 2% and 25% of total wells at the reservoir. The input data 210 (e.g., the well log data 212 and/or the core data 214) can include one or more of electrical resistivity data, gamma ray detection data, neutron porosity data, bulk density data, sonic log data, dielectric log data, nuclear magnetic resonance (NMR) logs, and/or the like. At least a portion of the core data 214 may be a subset or otherwise included in the well log data 212 and/or at least a portion of the core data 214 may be separate data (e.g., a different data file, data structure, and/or data format) from the well log data 212.

In some examples, geological facies class labels 216 are included in the input data set 210 or otherwise provided to the decision-tree based model(s) 206. The geological facies class labels are identifiers for distinct geological facies (e.g., including one or more alphanumeric symbols and/or identifying words). The geological facies class labels 216 can be provided by one or more subject matter experts (SME), for instance to reduce computational resources and/or improve accuracy of the predictive analytical model 204. For instance, the wellbore modeling platform 102 can present a user interface to receive input from the SME defining one or more geological facies class labels 216. Additionally, or alternatively, at least some of the geological facies class labels 216 can be generated by a machine learning technique. In some instances, the input data set 210 set can be artificially balanced to generate a balanced input data set so that under sampled geological facies class labels 216 (e.g., forming a minority class) are given a greater weight. The input data set 210 can include any number of geological facies class labels, such as between two and 20 geological facies class labels 216.

The collection of reservoir-based data may be combined into the input data set 210 for use by a supervised machine learning system, such as the decision tree-based model(s) 206, to generate the predictive analytical model 204. A target variable 218 is assigned for the decision tree-based model(s) 206, such as geological facies class, such that relationships between the different geological facies classes and their factors can be identified from the input data set 210. In some implementation, the decision tree-based model(s) 206 uses pattern recognition techniques to generate classification trees indicating how particular well log data characteristics correlate to particular geological facies class labels. For instance, the decision tree-based model(s) 206 may determine conjunctions of features from the input data set 210 (e.g. well-related features, reservoir-related features, and/or geological-related features) and interrelations of the conjunctions that have a higher statistical probability of corresponding to a particular geological facie class label. Moreover, vertical context data 220 can be provided to the decision tree-based model(s) 206 to further refine the decision tree-based model(s) 206. The vertical context data 220 can include supplementary data indicating depth values (e.g., measured values and/or predicted values) associated with the well log data 212 and/or the core data 214 of the input data set 210. The decision tree-based model(s) 206 can categorize various decision branches based on the vertical context data 220 so that multiple models can represent multiple different depths, resulting in predicted geological facies classes for particular depths.

In some examples, the data flow 200 generates the predictive analytical model 204 by iteratively training multiple decision tree model(s) 206 with a regression algorithm 224 and training/validation diagnostics algorithm 226. For example, the decision tree-based model(s) 206 can train and validate the various generated models with the input data set 210. In one implementation, the training/validation diagnostics algorithm 226 may be applied to each generated decision tree-based model 206 to determine an accuracy of the model with respect to the input data set 210. Through a determined error obtained from application of the various decision tree-based models 206 to the training/validation diagnostics algorithm 226, the data flow 200 can determine how accurate or how closely the generated model corresponds to the input data set 210. The data flow 200 can then alter the generated decision tree-based model 206 based on the determined error to address and attempt to eliminate the error. This process of model generation, regression, validation, and alteration may be repeated until the determined error of the decision tree-based model(s) 206 (according to the training/validation diagnostics algorithm 226), falls below a threshold value. In this manner, the data flow 200 utilizes regression techniques to generate or alter the decision tree-based model(s) 206 that are trained, through the above-described iterative process, to accurately represent the input data set 210.

In some instances, the predictive analytical model 204 uses a gradient boosting model, which provides predictions in the form of an ensemble of weak prediction decision tree-based model(s) 206, and builds the prediction in a stage-wise fashion. More particularly, gradient boosting involves using an additive model to add weak learners to minimize a loss function. Any of the features discussed herein can be used to generate the predictive analytical model 204.

In some examples, the predictive analytical model 204 receives the target well data 208 and, using the decision tree-based model(s) 206, generates the geological facies model 202. The target well data 208 can include location data (e.g., representing a single location, multiple locations, and/or a zone), well-related data, reservoir-related data, and/or geological-related data (e.g., like the input data set 210) for a particular geographic location or geographic area. For instance, the target well data 208 may be related to a candidate well or a candidate location for drilling the candidate well. Moreover, the target well data 208 can represent a geographic area being considered for drilling or surveying, such as a candidate section, area, or zone of a reservoir field or a candidate section of the reservoir below the reservoir field. The target well data 208 can include geographic information (e.g., Global Positioning System (GPS) data), and/or the vertical context data 220 related to the target well data 208 (e.g., for predicting geological facies class labels 216 at particular depths). In some instances, the target well data 208 includes well log data for the target location, but lacks core data for the target location. The target well data 208 may be an incomplete data set with respect to core sampling information.

In some examples, the predictive analytical model 204 provides the target well data 208 to the one or more decision tree-based model(s) 206 and outputs the geological facies model 202 based on one or more classifications generated by the decision tree-based model(s) 206. The one or more classifications can include a numerical (e.g., weighted) mapping of depths to particular geological facies class labels 216 predicted by the decision tree based model(s) 206 for the particular depths, based on the target well data 208 (e.g., and as categorized or defined by the vertical context data 220). For instance, multiple geological facies class labels 216 may be predicted sequentially for a sequence of depth values, starting at a surface level or sub-surface level depth, at a location (e.g., or multiple locations) associated with the target well data 208. The numerical mapping of the target well data 208 at various depths to the geological facies class labels 216 forms the geological facies model 202.

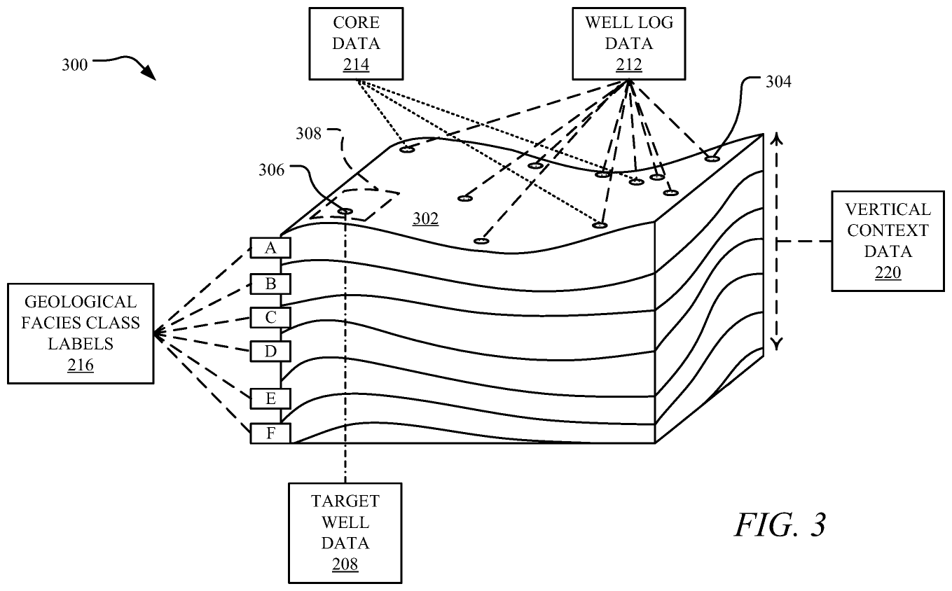

In some instances, the data flow 200 (e.g., as executed by the wellbore modeling platform 102) can provide the geological facies model 202 to a well location selection optimizer 228 for optimizing a well development selection. The well development selection can include selecting a section of the subsurface reservoir for further resource characterization and/or determining an optimal drilling location for a candidate well. Operations of the well location selection optimizer 228 are discussed in greater detail below regarding FIG. 3.

FIG. 3 illustrates an example system 300 for generating the geological facies model 202 and optimizing a well development selection, which can be performed by any of the systems discussed herein. The system 300 can include a reservoir field 302 (e.g., an oil and/or natural gas field) with a plurality of wells 304. The well log data 212 corresponds to the plurality of wells 304 and the core data 214 corresponds to the plurality of wells 304 or a subset of the plurality of wells 304. Generally, due to the expenses associated with extracting and analyzing core samples, the core data 214 represents less wells than the well log data 212.

In some examples, the target well data 208 represents a target or candidate location 306 for potentially drilling a target or candidate well, or performing another well development action. Additionally, or alternatively, the target well data 208 represents a target area or section 308 of the reservoir field 302 (e.g., and/or a section of the reservoir below the section 308 of the reservoir field 302) being assessed for determining an optimal location within the section 308 of the reservoir field 302 to perform the well development action and/or whether to perform additional resource characterization for the section 308 of the reservoir. The target well data 208 can represent multiple candidate locations 306 and/or multiple sections 308 of the reservoir field 302, for instance, to generate multiple geological facies models 202 to be compared against each other via an optimization process.

Providing the target well data 208 to the predictive analytical model 204 can improve well development by optimizing selection of the section 308 or the candidate location 306 (e.g., from among multiple candidate locations 306 and/or multiple candidate sections 308) for a well development action, even if the target well data 208 is incomplete (e.g., lacks corresponding core data at the candidate location 306 or section 308). For instance, the predictive analytical model 204 can generate the geological facies model 202 or multiple geological facies models 202 representing the candidate location 306 and/or the section 308. The geological facies model 202 can map (e.g., with one or more numerical weights) the geological facies class labels 216 to the target well data 208. Accordingly, the geological facies model 202 indicates a prediction or likelihood of which geological facies represented by the geological facies class labels 216 are present at different depths at the candidate location 306 and/or section 308 For instance, the geological facies model 202 can indicate that a first geological facie associated with a first geological facie class label is likely to be present at a first depth, a second geological facie associated with second geological facie class label is likely to be present at a second depth, and so forth. The geological facies model 202 can indicate starting depths and terminating depths of the different geological facies, and changes in the geological facies at different depths (e.g., changes in sedimentary composition at various depths). The system 300 can use the vertical context data 220 (e.g., which may include depth values associated with the input data set 210 and/or the target well data 208) to correlate or aggregate data based on relations to similar or identical depth values (e.g., relative to sea level or a surface depth value).

The well location selection optimizer 228 can assess the geological facies model 202 or multiple geological facies models 202 and determine, based at least partly on the geological facies model(s) 202, that the candidate location 306 and/or the section 308 satisfy one or more criteria for the development action. For instance, the geological facies model(s) 202 can indicate that likelihood of a petroleum trap being present at the candidate location 306 and/or section 308 is greater than a predetermined threshold value, that a predicted 12-month cumulative in barrels of oil equivalent (BOE) per foot (boe/ft) is greater than the predetermined threshold value, an estimated ultimate recovery (EUR) in millions of BOE is greater than the predetermined threshold value, a predicted bulk volume hydrocarbon (BVH) is greater than the predetermined threshold value, and the like. The well development action can be drilling a well at the candidate location 306 or at an optimal location in the section 308 of the reservoir field 302, conducting additional surveying at the candidate location 306 and/or the section 308 (e.g., performing resource characterization), using a particular well spacing, well orientation and placement, well length, completion, central infrastructure, making a depth-based equipment decision, and/or combinations thereof. In making the selection, the selection optimizer can consider the geological facies model 202 and/or a combinations of other variables that would maximize the resource output or increase efficiency.

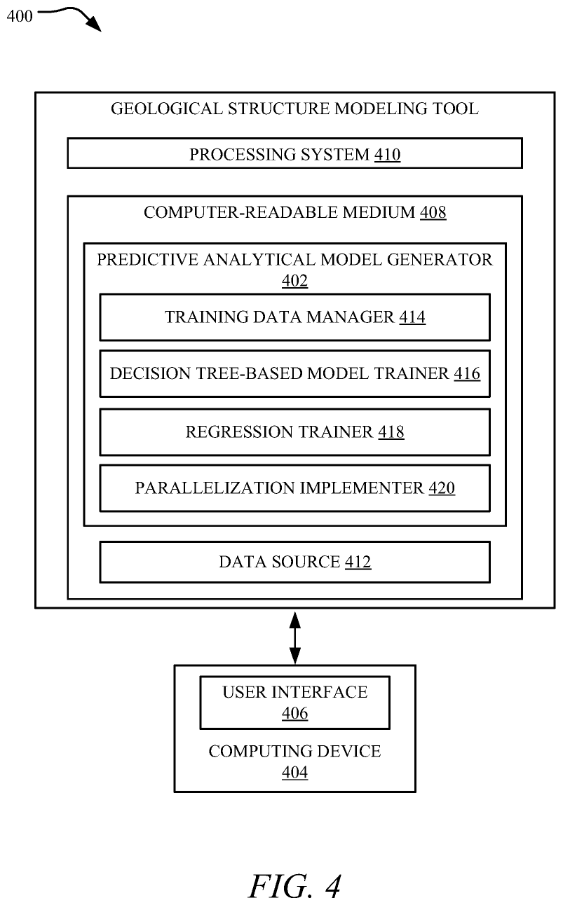

FIG. 4 illustrates an example block diagram of a geological structure modeling tool 400 for generating the geological facies model 202. In general, the geological structure modeling tool 400 may include a predictive analytical model generator 402 for generating the predictive analytical model 204 according to the data flow 200. The geological structure modeling tool 400 may form at least a portion of the wellbore modeling platform 102 of FIG. 1. As shown in FIG. 4, the geological structure modeling tool 400 may include or be in communication with a computing device 404 providing a user interface 406. As explained in more detail below, the geological structure modeling tool 400 may be accessible to various users to generate the predictive analytical model 204 and the geological facies model 202 based on the target well data 208 and/or the input data set 210 (e.g., which may be provided to the geological structure modeling tool 400 by the user). Access to the geological structure modeling tool 400 may occur through the user interface 406 executed on the computing device 404.

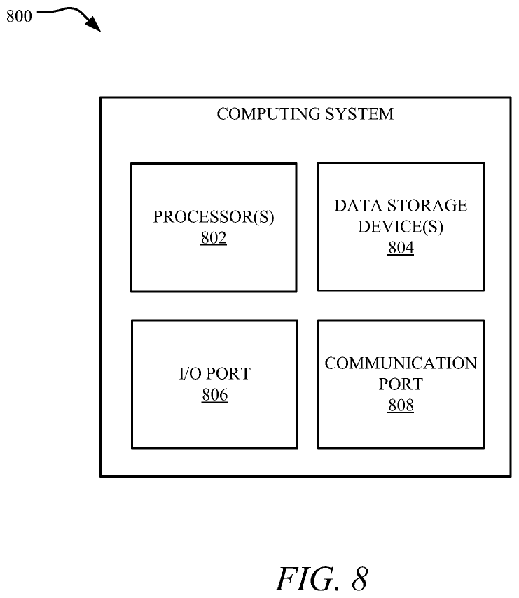

As explained above, the geological structure modeling tool 400 may generate the geological facies model 202 based on the input data set 210. Thus, the geological structure modeling tool 400 may include the predictive analytical model generator 402 executed to perform one or more of the systems and operations described herein. The predictive analytical model generator 402 may be an application stored in a computer-readable media 408 (e.g., memory) and executed on a processing system 410 of the geological structure modeling tool 400 or other type of computing system, such as that described below regarding FIG. 8. For example, predictive analytical model generator 402 may include instructions that may be executed in an operating system environment, such as a Microsoft Windows™ operating system, a Linux operating system, or a UNIX operating system environment. The computer-readable media 408 includes volatile media, nonvolatile media, removable media, non-removable media, and/or another available medium. By way of example and not limitation, non-transitory computer-readable media 408 comprises computer storage media, such as non-transient storage memory, volatile media, nonvolatile media, removable media, and/or non-removable media implemented in a method or technology for storage of information, such as computer readable instructions, data structures, program modules, or other data.

The predictive analytical model generator 402 may also utilize a data source 412 of the computer-readable media 408 for storage of data and information associated with the geological structure modeling tool 400. For example, the predictive analytical model generator 402 may store information associated with iterations of the decision tree-based model(s) 206, outputs of the predictive analytical model 204, training/validation diagnostic information or data, model accuracy scoring, geological facies model(s) 202, and the like. As described in more detail below, various generated models and profiles may be stored and used via the user interface 406 to simulate or otherwise determine geological facies models 202 such that trained or optimized models and profiles for various target wells may be stored in the data source 412.

The predictive analytical model generator 402 may include several components to perform one or more of the operations described herein. For example, the predictive analytical model generator 402 may include a training data manager 414 to manage the input data set 210 for the decision tree-based model(s) 206 to generate the geological facies model 202 based on the input data set 210. The training data manager 414 may, in some instances, receive various types of data, such as well logs (e.g., the well log data 212), core logs (e.g., the core log data 214), well construction data, production data, seismic data, attribute data, and/or other types of well-related data and combine the data into the input data set 210 for use in generating the geological facies model 202. Further, the training data manager 414 may also manage training/validation diagnostic information and data used in determining an accuracy of the decision tree-based model(s) 206 and/or the geological facies model 202 as compared to the input data set 210. For example, the training data manager 414 may compare simulated results of the geological facies model 202 and determine a difference between the simulated results and the input data set 210 to determine an accuracy of the generated model. Past results of the training of the model may also be stored and/or maintained by the training data manager 414 for comparison to current results to determine if the generated model is becoming more accurate or less accurate in response to operations performed by the geological structure modeling tool 400. In general, any information or data provided as inputs to the decision tree-based model(s) 206 and/or utilized to train or validate the predictive analytical model 204 may be managed by the training data manager 414.

The predictive analytical model generator 402 may also include a decision tree-based model trainer 416 and regression trainer 418 to generate and/or train one or more decision tree-based model(s) 206 based on the input data set 210 received from the training data manager 414. As explained above, the decision tree-based model trainer 416 may include any machine learning, deep learning, or artificial intelligence techniques (e.g., a supervised machine learning system) to generate the decision tree-based models 206, such as multiple decision tree-based models 206 via an iterative process. The regression trainer 418 may reduce the complexity of the generated models and profiles and apply the models to the training/validation diagnostics algorithm 226 for iterative training. Together, the decision tree-based model trainer 416 and regression trainer 418 may develop a plurality of trained decision tree-based models 206.

A parallelization implementer 420 may also be included and executed by the predictive analytical model generator 402. In one non-limiting example, the parallelization implementer 420 may manage the parallelization of the training of the generated decision tree-based models 206 and the predictive analytical model 204 and/or model scoring with a high-performance cluster (HPC). For instance, the overall data flow process described above with relation to FIG. 2 may be distributed across an HPC of computing devices. The various trained models (e.g., trained decision tree-based models 206 and/or trained predictive analytical models 204) generated by the iterative process may be scored in parallel through a distribution of the trained models onto various computing machines of the HPC. In this manner, the simulations executed on the trained models and the accuracy scores of the various models may be obtained simultaneously to reduce the time needed to complete the model evaluations. In a similar manner, multiple computing devices may execute the deep learning techniques in a parallel manner to generate the multiple trained models for the target well simultaneously such that the trained models may be generated at a faster rate than previous implementations that may generate the trained models serially. For example, the parallelization implementer 420 may provide the generated models to one or more computing devices of the HPC for training, simulation, and comparing to the diagnostic data. Similarly, the parallelization implementer 420 may communicate with one or more computing devices of the HPC to apply measured data to the trained models to determine an accuracy of the trained models. In general, any communication between the predictive analytical model generator 402 and the HPC may be managed by the parallelization implementer 420 to reduce the time to generate the decision tree-based model(s) 206, the predictive analytical model 204, and/or the geological facies model 202. It will be appreciated that HPC clusters are just one example of learning techniques that may be utilized.

Further, it will be appreciated that the components described herein are provided only as examples, and that the geological structure modeling tool 400 may have different components, additional components, or fewer components than those described herein. For example, one or more components as described in FIG. 4 may be combined into a single component. As another example, certain components described herein may be encoded on, and executed on other computing systems. Any components of the geological structure modeling tool 400 may be combined or included with the components of the computing system 800 discussed in greater detail below regarding FIG. 8, the wellbore modeling platform 102, and/or the user device 106.

Several advantages over previous techniques for predicting geological facies may be gained through the methods and systems described herein. For example, the wellbore modeling platform 102 may facilitate data loading, pre-processing, transformation and alignment to the well log data, a dynamic and flexible model construction process, and data handling, generation, augmentation during model training. Other advantages include automated techniques for model validation, automated capture of model training results, and automated implementation of model hyper-parameter optimization to repeatedly train new models in a search for the optimal model configuration. In some non-limiting examples, the described modeling framework may also be used to streamline user access to Graphical Processing Unit (GPU) resources in the HPC to improve model training speed and a visualization and data framework allows users to track model optimization. The model prediction framework may also distribute the prediction tasks out to as many computational resources as desired in order to speed up the process while automatically taking care of the hardware resourcing, setup, and take-down tasks. Still other advantages include an efficient process that makes it easy for users to connect their data to the modeling tools while receiving the results a short time later, even if core data related to the target well 208 is lacking. Moreover, automating portions of the modeling process with the machine learning and artificial intelligence techniques described herein can reducing interpretation bias common in previous reservoir model generation systems.

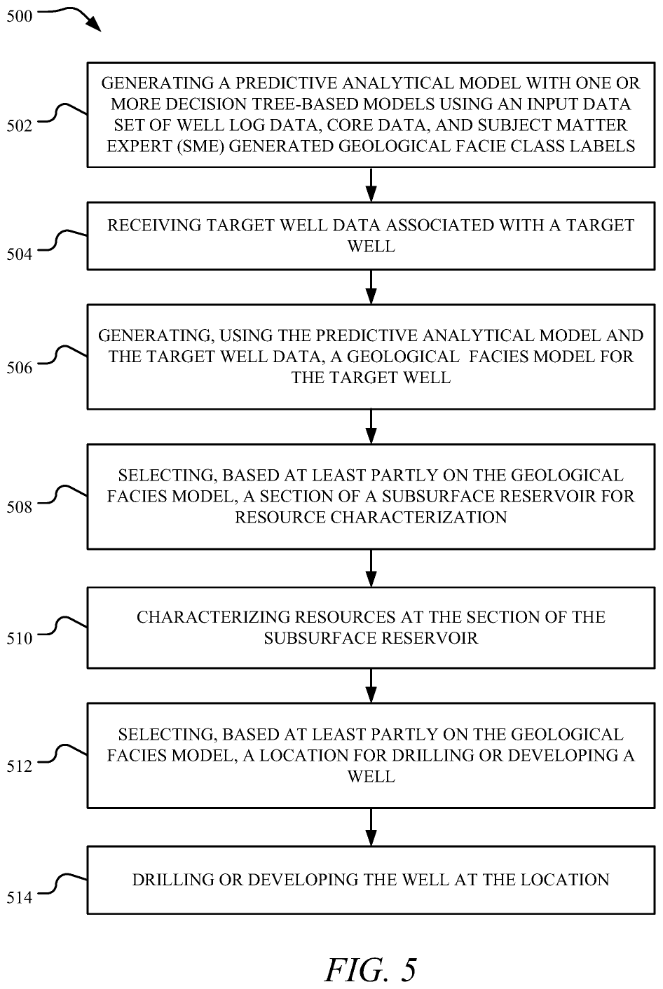

FIG. 5 illustrates example operations of a method 500 for optimizing a well development action by generating the geological facies model 202, which can be performed by any of the systems discussed herein. At operation 502, the method 500 can include generating the predictive analytical model 204 with the one or more decision tree-based model(s) 206 using the input data set 210 of the well log data 212, the core data 214, and/or the geological facies class labels 216. At operation 504, the method 500 can include receiving the target well data 208 associated with a target well. At operation 506, the method 500 can include generating, using the predictive analytical model 204 and the target well data 208, the geological facies model 202 for the target well. At operation 508, the method 500 can include selecting, based at least partly on the geological facies model 202, the section 308 of a reservoir for resource characterization. At operation 510, the method 500 can include characterizing resources at the section 308 of the reservoir. At operation 512, the method 500 can include selecting, based at least partly on the geological facies model 202, the candidate location 306 for drilling or developing a well. At operation 514, the method 500 can include drilling or developing the well at the candidate location 306.

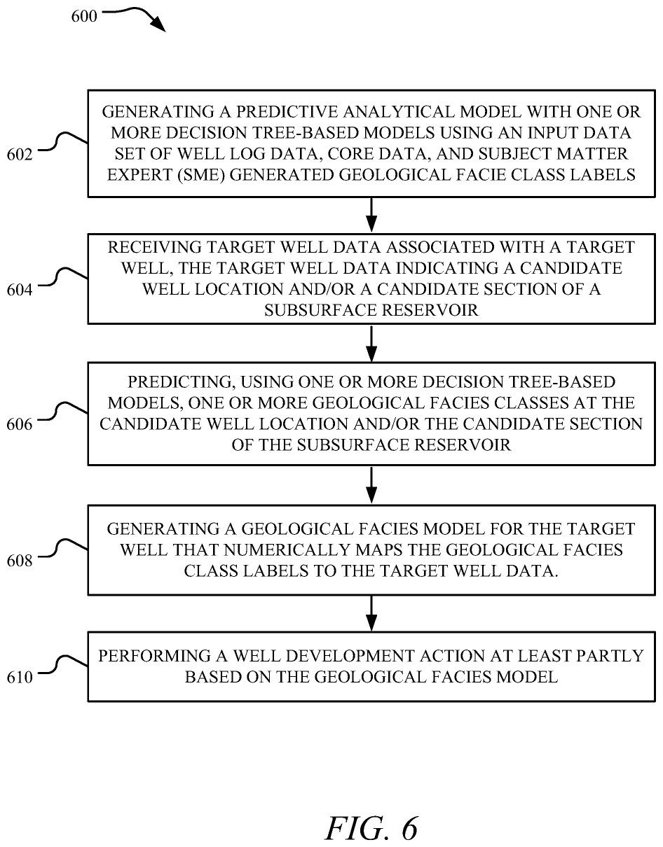

FIG. 6 illustrates example operations of a method 600 for generating the geological facies model 202 with one or more decision tree-based model(s) 206, which can be performed by any of the systems discussed herein. At operation 602, the method 600 can include generating the predictive analytical model 204 with the one or more decision tree-based model(s) 206 using the input data set 210 of the well log data 212, the core data 214, and/or the geological facies class labels 216. At operation 604, the method 600 can include receiving the target well data 208 associated with a target well, the target well data 208 indicating the candidate well location 306 and/or a candidate section of a subsurface reservoir (e.g., the section 308 of the reservoir field 302 above the candidate section of the subsurface reservoir). At operation 606, the method 600 can include predicting, using the one or more decision tree-based model(s) 206, one or more geological facie classes numerically mapped to one or more depth values at the candidate well location 306 and/or the candidate section of the subsurface reservoir. At operation 608, the method 600 can include generating the geological facies model 202 for the target well that numerically maps the geological facies class labels 216 to the target well data 208. At operation 610, the method 600 can include performing a well development action at least partly based on the geological facies model 202. For instance, the method 600 can include drilling a well at the candidate location 306 or at the section 308 of the reservoir field 302 and/or performing resource characterization at the candidate location 306 or the section 308 of the reservoir field 302.

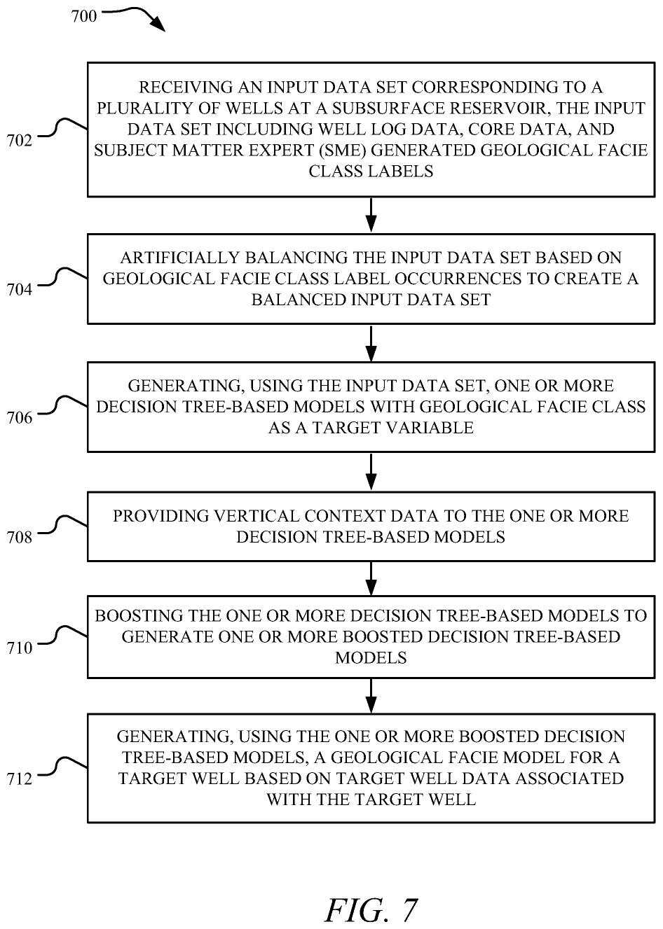

FIG. 7 illustrates example operations of a method 700 for generating the predictive analytical model 204 to generate the geological facies model 202, which can be performed by any of the systems discussed herein. At operation 702, the method 700 can include receiving the input data set 210 corresponding to a plurality of wells at a subsurface reservoir, the input data set 210 including the well log data 212, the core data 214, and/or the geological facies class labels 216 generated by an SME. At operation 704, the method 700 can include artificially balancing the input data set 210 based on geological facies class label 216 occurrences to create a balanced input data set. At operation 706, the method 700 can include generating, using the input data set 210, the one or more decision tree-based model(s) 206 with geological facie class as the target variable 218. At operation 708, the method 700 can include providing the vertical context data 220 to the one or more decision tree-based model(s) 206. At operation 710, the method 700 can include boosting the one or more decision tree-based model(s) to generate one or more boosted decision tree-based model(s). At operation 712, the method 700 can include generating, using the one or more boosted decision tree-based models, the geological facies model 202 for a target well based on the target well data 208 associated with the target well.

It is to be understood that the specific order or hierarchy of operations in the methods depicted in FIGS. 5-7 are instances of example approaches and can be rearranged while remaining within the disclosed subject matter. For instance, any of the operations depicted in FIGS. 5-7 may be omitted, repeated, performed in parallel, performed in a different order, and/or combined with any other of the operations depicted in 5-7 or throughout this disclosure.

Referring to FIG. 8, a detailed description of an example computing system 800 having one or more computing units that may implement various systems and methods discussed herein is provided. The computing system 800 may be applicable to the wellbore modeling platform 102, the network environment 100, and other computing or network devices. In some instances, the computing system 800 may be similar or identical to the user device 106, the geological structure modeling tool 400, the computing device 400, the server 108, and the like. It will be appreciated that specific implementations of these devices may be of differing possible specific computing architectures not all of which are specifically discussed herein but will be understood by those of ordinary skill in the art.

The computing system 800 may be capable of executing a computer program product to execute a computer process. Data and program files may be input to the computing system 800, which reads the files and executes the programs therein. Some of the elements of the computing system 800 are shown in FIG. 8, including one or more hardware processors 802 (e.g., which may be similar or identical to the processing system 410 in FIG. 4), one or more data storage devices 804, such as memory devices (e.g., which may be similar or identical to the computer-readable media 408 in FIG. 4), and/or one or more ports 806 or 808. Additionally, other elements that will be recognized by those skilled in the art may be included in the computing system 800 but are not explicitly depicted in FIG. 8 or discussed further herein. Various elements of the computing system 800 may communicate with one another by way of one or more communication buses, point-to-point communication paths, or other communication means not explicitly depicted in FIG. 8.

The processor 802 may include, for example, a central processing unit (CPU), a microprocessor, a microcontroller, a digital signal processor (DSP), and/or one or more internal levels of cache. There may be one or more processors 802, such that the processor 802 comprises a single central-processing unit, or a plurality of processing units capable of executing instructions and performing operations in parallel with each other, commonly referred to as a parallel processing environment.

The computing system 800 may be a conventional computer, a distributed computer, or any other type of computer, such as one or more external computers made available via a cloud computing architecture. The presently described technology is optionally implemented in software stored on the data stored device(s) 804, (e.g., memory device(s)), and/or communicated via one or more of the ports 806 or 808, thereby transforming the computing system 800 in FIG. 8 to a special purpose machine for implementing the operations described herein. Examples of the computing system 800 include personal computers, terminals, workstations, mobile phones, tablets, laptops, personal computers, multimedia consoles, gaming consoles, set top boxes, and the like.

The one or more data storage devices 804 may include any non-volatile data storage device capable of storing data generated or employed within the computing system 800, such as computer executable instructions for performing a computer process, which may include instructions of both application programs and an operating system (OS) that manages the various components of the computing system 800. The data storage devices 804 may include, without limitation, magnetic disk drives, optical disk drives, solid state drives (SSDs), flash drives, and the like. The data storage devices 804 may include one or more memory devices such as removable data storage media, non-removable data storage media, and/or external storage devices made available via a wired or wireless network architecture with such computer program products, including one or more database management products, web server products, application server products, and/or other additional software components. Examples of removable data storage media include Compact Disc Read-Only Memory (CD-ROM), Digital Versatile Disc Read-Only Memory (DVD-ROM), magneto-optical disks, flash drives, and the like. Examples of non-removable data storage media include internal magnetic hard disks, SSDs, and the like. The one or more memory devices can include volatile memory (e.g., dynamic random access memory (DRAM), static random access memory (SRAM), etc.) and/or non-volatile memory (e.g., read-only memory (ROM), flash memory, etc.).

Computer program products containing mechanisms to effectuate the systems and methods in accordance with the presently described technology may reside in the data storage devices 804, which may be referred to as machine-readable media. It will be appreciated that machine-readable media may include any tangible non-transitory medium that is capable of storing or encoding instructions to perform any one or more of the operations of the present disclosure for execution by a machine or that is capable of storing or encoding data structures and/or modules utilized by or associated with such instructions. Machine-readable media may include a single medium or multiple media (e.g., a centralized or distributed database, and/or associated caches and servers) that store the one or more executable instructions or data structures. The machine-readable media may store instructions that, when executed by the processor, cause the systems to perform the operations disclosed herein.

In some implementations, the computing system 800 includes one or more ports, such as an input/output (I/O) port 806 and a communication port 808, for communicating with other computing, network, or reservoir development devices. It will be appreciated that the ports 806 and 808 may be combined or separate and that more or fewer ports may be included in the computing system 800.

The I/O port 806 may be connected to an I/O device, or other device, by which information is input to or output from the computing system 800. Such I/O devices may include, without limitation, one or more input devices, output devices, and/or environment transducer devices.

In some implementations, the input devices convert a human-generated signal, such as, human voice, physical movement, physical touch or pressure, and/or the like, into electrical signals as input data into the computing system 800 via the I/O port 806. Similarly, the output devices may convert electrical signals received from computing system 800 via the I/O port 806 into signals that may be sensed as output by a human, such as sound, light, and/or touch. The input device may be an alphanumeric input device, including alphanumeric and other keys for communicating information and/or command selections to the processor 802 via the I/O port 806. The input device may be another type of user input device including, but not limited to: direction and selection control devices, such as a mouse, a trackball, cursor direction keys, a joystick, and/or a wheel; one or more sensors, such as a camera, a microphone, a positional sensor, an orientation sensor, a gravitational sensor, an inertial sensor, and/or an accelerometer; and/or a touch-sensitive display screen (“touchscreen”). The output devices may include, without limitation, a display, a touchscreen, a speaker, a tactile and/or haptic output device, and/or the like. In some implementations, the input device and the output device may be the same device, for example, in the case of a touchscreen.

In some implementations, a communication port 808 is connected to a network by way of which the computing system 800 may receive network data useful in executing the methods and systems set out herein as well as transmitting information and network configuration changes determined thereby. Stated differently, the communication port 808 connects the computing system 800 to one or more communication interface devices configured to transmit and/or receive information between the computing system 800 and other devices by way of one or more wired or wireless communication networks or connections. Examples of such networks or connections include, without limitation, Universal Serial Bus (USB), Ethernet, Wi-Fi, Bluetooth®, Near Field Communication (NFC), Long-Term Evolution (LTE), and so on. One or more such communication interface devices may be utilized via the communication port 808 to communicate one or more other machines, either directly over a point-to-point communication path, over a wide area network (WAN) (e.g., the Internet), over a local area network (LAN), over a cellular (e.g., third generation (3G) or fourth generation (4G) or fifth generation (5G) network), or over another communication means. Further, the communication port 808 may communicate with an antenna or other link for electromagnetic signal transmission and/or reception.

The computing system 800 set forth in FIG. 8 is but one possible example of a computer system that may employ or be configured in accordance with aspects of the present disclosure. It will be appreciated that other non-transitory tangible computer-readable storage media storing computer-executable instructions for implementing the presently disclosed technology on a computing system may be used. In the present disclosure, the methods and operations disclosed herein may be implemented as sets of instructions or software readable by a device.

For instance, the described disclosure may be provided as a computer program product, or software, that may include a non-transitory machine-readable medium having stored thereon instructions, which may be used to program a computer system (or other electronic devices) to perform a process according to the present disclosure. A machine-readable medium includes any mechanism for storing information in a form (e.g., software, processing application) readable by a machine (e.g., a computer). The machine-readable medium may include, but is not limited to, magnetic storage medium, optical storage medium; magneto-optical storage medium, read only memory (ROM); random access memory (RAM); erasable programmable memory (e.g., EPROM and EEPROM); flash memory; or other types of medium suitable for storing electronic instructions.

While the present disclosure has been described with reference to various implementations, it will be understood that these implementations are illustrative and that the scope of the present disclosure is not limited to them. Many variations, modifications, additions, and improvements are possible. More generally, implementations in accordance with the present disclosure have been described in the context of particular implementations. Functionality may be separated or combined in blocks differently in various implementations of the disclosure or described with different terminology. These and other variations, modifications, additions, and improvements may fall within the scope of the disclosure as defined in the claims that follow.

What is claimed is:

1. A method for modeling geological facies of a subsurface reservoir, the method comprising:
generating a predictive analytical model of the subsurface reservoir by:
creating one or more decision tree-based models trained with an input data set including well log data associated with the subsurface reservoir; and
assigning geological facies class as a target variable;
receiving target well data corresponding to a target well associated with the subsurface reservoir; and
generating, using the target well data and the predictive analytical model, a geological facies model for the target well.

2. The method of claim 1, wherein the well log data of the input data set includes core data associated with a plurality of wells at the subsurface reservoir.

3. The method of claim 1, further comprising labeling, using a subject matter expert (SME), the input data set with a plurality of geological facie class labels.

4. The method of claim 1, wherein the target well data lacks a core data set associated with the target well.

5. The method of claim 1, wherein generating the predictive analytical model includes artificially balancing a plurality of geological facies class labels associated with the input data set to create a balanced input data set.

6. The method of claim 5, wherein the plurality of geological facies class labels includes at least two geological facies class labels.

7. The method of claim 1, wherein generating the predictive analytical model further includes providing vertical context data to the one or more decision tree-based models.

8. The method of claim 1, wherein the one or more decision tree-based models include a gradient boosted decision tree.

9. The method of claim 1, wherein the well log data of the input data set represents at least five wells at the subsurface reservoir.

10. The method of claim 1, wherein the input data set includes at least one of resistivity data, gamma ray data, neutron porosity data, bulk density data, sonic log data, dielectric log data, or nuclear magnetic resonance (NMR) logs.

11. The method of claim 1, wherein generating the geological facies model for the target well includes numerically mapping the target well data to specific geographic facies represented by the input data set.

12. The method of claim 1, further comprising selecting, based at least partly on the geological facies model, a section of the subsurface reservoir for resource characterization.

13. The method of claim 1, wherein the target well is a candidate well for drilling, the method further comprises:
determining, based at least partly on the geological facies model, an optimal drilling location for the candidate well; and
drilling the candidate well at the optimal drilling location.

14. One or more tangible non-transitory computer-readable storage media storing computer-executable instructions for performing a computer process on a computing system, the computer process comprising:
generating a predictive analytical model of the subsurface reservoir by:
creating one or more decision tree-based models trained with an input data set including well log data associated with the subsurface reservoir; and
assigning geological facies class as a target variable;
receiving target well data corresponding to a target well associated with the subsurface reservoir; and
generating, using the target well data and the predictive analytical model, a geological facies model for the target well.

15. The one or more tangible non-transitory computer-readable storage media of claim 14, wherein the target well data lacks a core data set associated with the target well.

16. The one or more tangible non-transitory computer-readable storage media of claim 14, wherein generating the predictive analytical model includes artificially balancing a plurality of geological facies class labels associated with the input data set to create a balanced input data set.

17. The one or more tangible non-transitory computer-readable storage media of claim 14, wherein generating the predictive analytical model further includes providing vertical context data to the one or more decision tree-based models.

18. The one or more tangible non-transitory computer-readable storage media of claim 14, wherein generating the geological facies model for the target well includes numerically mapping the target well data to specific geographic facies represented by the input data set.

19. The one or more tangible non-transitory computer-readable storage media of claim 14, wherein the target well is a candidate well for drilling, the method further comprises:
determining, based at least partly on the geological facies model, an optimal drilling location for the candidate well; and
drilling the candidate well at the optimal drilling location.

20. A system for modeling geological facies of a subsurface reservoir, the system comprising:
a wellbore modeling platform configured to generate a predictive analytical model of the subsurface reservoir, the predictive model generated by creating one or more decision tree-based models trained with an input data set associated with the subsurface reservoir and assigning geological facies class as a target variable, the wellbore modeling platform receiving target well data corresponding to a target well and generating a geological facies model for the target well using the target well data and the predictive analytical model.
